(19) United States
(12) Patent Application Publication
(10) Pub. No.: US 2009/0141274 A1
(43) Pub. Date: Jun. 4, 2009

(54) Polarization Dependent Loss Analyzer

(76) Inventors: Bogdan Szafraniec, Sunnyvale, CA (US); Evan Paul Thrush, San Jose, CA (US); Calivin Bruce Ward, Castro Valley, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/947,745

(22) Filed: Nov. 29, 2007

(51) Int. Cl. G01J 4/00

(52) U.S. Cl. 356/364

(57) ABSTRACT

A polarization dependent loss measuring device and the method of using the same are disclosed. The device includes a light source, a sensor, and a controller. The light source generates a polarization modulated light signal, and is adapted to apply the polarization modulated light signal to a device under test. The sensor generates an electrical output signal representing an intensity of an output light signal leaving the device under test as a function of time. The controller measures an amplitude and phase of the electrical output signal at a first frequency and generates an output indicative of a polarization dependent loss in the device under test.

### BACKGROUND OF THE INVENTION

Devices based on the transmission and processing of optical signals are becoming increasingly common. Computer and communication networks that utilize optical fibers for the transmission of data are now commonplace. Such networks rely on optical fibers and other elements such as light amplifiers, multiplexers, demultiplexers, dispersion compensators, etc. to carry and process the light signals. The passage of an optical signal through devices such as optical fibers results in a loss of intensity of the optical signal. The attenuation of the device often depends on the polarization state of the light signal being transmitted. The polarization dependent loss (PDL) can accumulate over the entire length of the optical network due to the multitude of optical components that makeup the network. Therefore, it is critical to make precise measurements of the components and to maintain low PDL throughout the optical network. Efficient methods, that provide precision and speed, for determining insertion loss and polarization dependent loss are required.

One prior art method for measuring the polarization dependent loss of a device requires that the power transmitted through the device for four different polarization states be measured. This method is often referred to as the Mueller-Stokes method. In this method, the power measurements are performed sequentially. That is, the power transmitted by the device for light having the first polarization state is measured, and then the power transmitted through the device for light having the second polarization is measured, and so on. The polarization dependent loss is determined from the individual measurements of power. The method assumes that the polarization dependent losses remain constant over the time frame of the measurement. Unfortunately, the polarization properties of many devices, such as optical fibers, can change if the device is moved or the temperature changes between measurements. Hence, vibration of the device or long measurement times can lead to erroneous measurements. In addition, for devices having small polarization losses, the method requires that the losses be computed by talking the weighted difference of much larger power measurements, and hence, small errors in the power measurements can lead to large errors in the measured polarization dependent loss.

### SUMMARY OF THE INVENTION

The present invention includes a polarization dependent loss measuring device and the method of using the same. The device includes a light source, a sensor, and a controller. The light source generates a polarization modulated light signal, and is adapted to apply the polarization modulated light signal to a device under test. The sensor generates an electrical output signal representing an intensity of an output light signal leaving the device under test as a function of time. The controller measures the electrical output signal at a first frequency and generates an output indicative of a polarization dependent loss in the device under test. In one aspect of the invention, the controller also measures an insertion loss associated with the device under test. In another aspect of the invention, the polarization modulated light signal includes a light signal in which all three Stokes vector polarization components are periodic functions of time, and the controller measures an amplitude and phase of the electrical output signal at each of first, second, and third modulation frequencies characterizing said periodic functions. In another aspect of the invention, the polarization modulated light signal is characterized by a path on a Poincare sphere. The path can be either closed or open depending on the choice of polarization modulated light signal. In a still further aspect of the invention, the controller includes an electrical vector spectrum analyzer or a lock-in amplifier that is used for making the amplitude and phase measurements.

### BRIEF DESCRIPTION OF THE DRAWINGS

FIG. 1 illustrates one embodiment of a polarization-dependent loss and insertion loss analyzer according to the present invention.

FIG. 2A illustrates the polarization space in which the Stokes vector is defined.

FIG. 2B illustrates another method for describing the polarization of a monochromatic optical wave.

FIG. 3 is a perspective view of a polarization modulator.

FIG. 4 is a cross-sectional view through line 4-4 of the polarization modulator shown in FIG. 3.

FIG. 5 is a perspective view of a Poincare sphere.

FIGS. 6 and 7 illustrate a polarization modulated light signal that can be used in one embodiment of the present invention.

FIG. 8 illustrates another polarization modulated light signal that can be used in an embodiment of the present invention.

FIGS. 9A-9C illustrate the modulation of the various Stokes vector components.

FIG. 10 illustrates the voltage waveforms that produce the trajectory shown in FIGS. 8 and 9.

### DETAILED DESCRIPTION OF THE PREFERRED EMBODIMENTS OF THE INVENTION

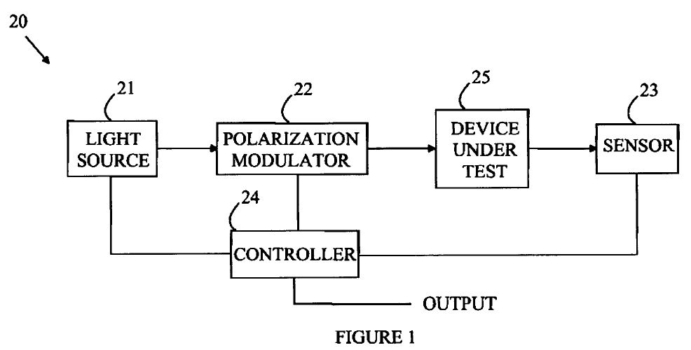

The manner in which the present invention provides its advantages can be more easily understood with reference to FIG. 1, which illustrates one embodiment of a polarization-dependent loss and/or insertion loss analyzer according to the present invention. Analyzer 20 includes a light source 21 that generates a light signal whose polarization is modulated by polarization modulator 22 prior to the light signal being applied to a device under test 25. The light leaving device under test 25 is input to a senor 23 that measures the power of the light leaving device under test 25 as a function of time. The light leaving device under test 25 can be light that is transmitted through device 25 or reflected from device 25. The operation of these components is under the control of controller 24 that also performs the computations needed to provide a measurement of the polarization-dependent loss and/or insertion loss of device under test 25.

The polarization of the light is modulated at a frequency whose period is much smaller than the time frame over which the properties of device under test 25 are expected to change due to temperature changes, vibration, or other physical changes in the state of device under test 25. The manner in which the polarization modulator operates will be explained in more detail below.

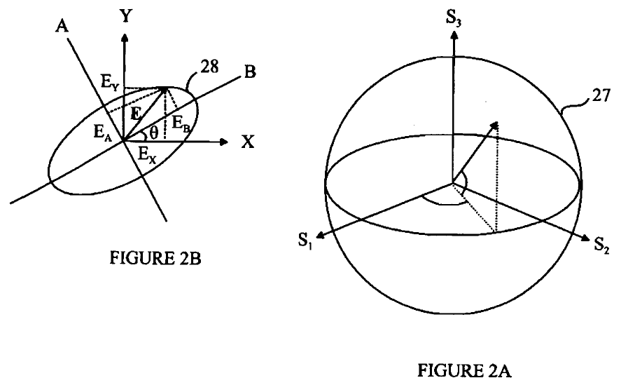

The operation of the present invention can be more easily understood in terms of the Stokes vector, which describes the state of polarization of a light signal. The Stokes vector has 4 components, S₀-S₃. The first component, S₀, is the intensity of the light signal and the remaining three components describe the state of polarization of the light signal. The polarization state of the light signal is represented as a vector in a three dimensional space in which the unit vectors along the three axes can be viewed as representing the fraction of the light with various types of polarization. The S₁ axis measures the content of linear polarization with the positive values corresponding to horizontally polarized light, and the negative values corresponding to vertically polarized light. The S₂ axis measures the content of linear polarization at 45 degrees to the horizontal (or vertical) with the positive values corresponding to +45 degree polarized light, and the negative values corresponding to −45 degree polarized light. Finally, the S₃ axis measures the content of circular polarization, the positive values representing right-hand circularly (right circular) polarized light and the negative values representing left-hand circularly (left circular) polarized light. The normalized Stokes vector has all its components normalized with respect to its first element. Thus, the normalized intensity is equal to one. Refer now to FIG. 2A, which illustrates the polarization space in which the normalized Stokes vector is defined. For a monochromatic optical signal, the polarization states of the light lie on a unit radius sphere 27 that is often referred to as the Poincare sphere.

The Stokes vector parameters can be related to the electric field of the light waves. Refer now to FIG. 2B, which illustrates another method for describing the polarization state of a monochromatic plane wave. In general, the plane wave is specified by its propagation vector and the complex amplitudes of the electric field vector in a plane perpendicular to the propagation vector. The propagation vector is perpendicular to the plane of FIG. 2B. In general, the electric field vector moves around an ellipse 28 in the plane. The path can be described in terms of an arbitrary coordinate system XY. The Stokes vector components are related to the components of the electric field vector, E, as follows:

S₀=|Eₓ51 ²+|E_{y}|²

S₁=|Eₓ|²−|E_{y}|²

S₂=2Re(E′ₓE_{y})

S₃=2Im(E′ₓE_{y}) (1)

It should be noted that the components of the electric field vector are complex values.

The Stokes vectors provide a useful means for describing the changes in polarization state that take place when a light signal passes through an optical element. In this type of mathematical model, the optical element is described by a matrix, referred to as the Mueller matrix. Given the Stokes vector of the light that enters the optical element, Sᵢₙ, the Stokes vector of the light leaving the optical element, Sₒᵤₜ, is given by

Sₒᵤₜ=MSᵢₙ (2)

where M is the Mueller matrix that describes the optical element. The Mueller matrix is a 4×4 matrix in which the first row describes the power losses in passing through the optical element. Hence, a polarization-dependent loss and insertion loss analyzer, in effect, can be viewed as a device that determines the first row of the Mueller matrix. That is, the power detected by power sensor 23 shown in FIG. 1 is

$${p}_{out} = {\sum }_{j}^{4} {m}_{1 , i} * {S}_{i - 1} \qquad ( 3 )$$

Referring again to FIG. 1, polarization modulator 22 causes the polarization state of the light passing therethrough to be altered continuously in a manner determined by the electrical input signals thereto without substantially altering the power of the optical signal. For the purposes of this discussion, a polarization modulator will be defined to be a device that modulates polarization state without substantial modulation of intensity. The insertion loss of the device is not relevant to the present invention; however, it typically is smaller than 5 dB. The action of the polarization modulator can be viewed in the Stokes vector space as causing the Stokes vector to traverse a path on the surface of the Poincare sphere. If the Stokes vector is modulated at a frequency f and one or more of the elements of the Muller matrix m_{1,i}, where i>1, are non-zero, then the measured power will also show a modulation at frequency f that can be detected by controller 24 and used to compute the m_{1,i}, provided the modulation of S satisfies certain conditions.

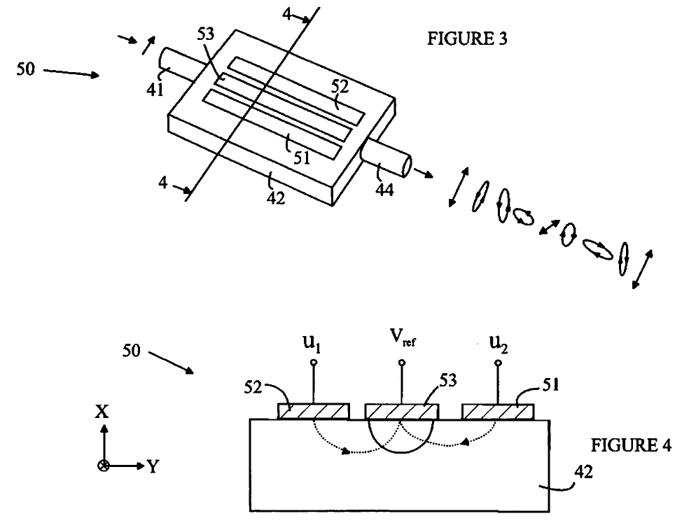

Refer now to FIGS. 3 and 4, which illustrate one class of polarization modulator that is capable of providing the modulation needed for the present invention. FIG. 3 is a perspective view of polarization modulator 50, and FIG. 4 is a cross-sectional view of polarization modulator 50 through line 4-4 shown in FIG. 3. Polarization modulator 50 is constructed from an x-cut, z-propagating LiNbO₃ 42 in which the light enters through input port 41, perpendicular to the face of the xy plane, and propagates in the z-direction. The top surface of crystal 42 includes three electrodes 51-53 that are used to apply potentials to the crystal. The potentials generate electric fields in the crystal that give rise to birefringence in the crystal. By correctly choosing the potentials, the polarization state can be altered such that the Stokes vector of the output signal can be moved to any point on the Poincare sphere.

The manner in which the potentials are chosen will be explained in more detail below. For the present discussion, it is sufficient to note that a first periodic waveform is applied between electrodes 53 and 52, and a second periodic waveform is applied between electrodes 53 and 51. Electrode 53 is a reference (ground) electrode. Typically, the waveforms have the same period. Over each period of the waveforms, the Stokes vector of the output light traverses a predetermined path (trajectory) on the surface of the Poincare sphere. The path is chosen such that all of the polarization dependent components of the Stokes vector are modulated with sufficient amplitude to measure the polarization dependent loss related to each component during each cycle of the applied waveforms. The path may also be chosen to have its center of gravity in the center of the sphere. This selection is optimal as all Stokes vector components are exercised equally. Then, the average detected intensity provides a precise measurement of the insertion loss.

Refer now to FIG. 5, which is a perspective view of the Poincare sphere. Consider a point 61 on the Poincare sphere that is on the desired trajectory 63. The Stokes vector that ends on this point has three components along the three axes in the Stokes vector space. The components are obtained by projecting the Stokes vector onto the three axes. The three projections are shown at q, u, and v. As the Stokes vector moves to a point 62 on the desired trajectory, these components increase and decrease depending on the particular location of the point at any given time. For the purposes of this discussion, it will be assumed that q(t), u(t), and v(t) are periodic functions and can be represented by a Fourier series having the same fundamental frequency for each Stokes component. This will be the case if the desired path/trajectory is a closed loop on the Poincare sphere. Each cycle of the modulation results in the polarization state moving once around the loop. As will be discussed in more detail below, the Stokes vector components can also be periodic functions even when the path/trajectory on the Poincare sphere is not closed. In this case, the Stokes vector components do not necessarily have the same fundamental frequency.

It should be noted, however, that while q(t), u(t) and v(t) are periodic, q(t), u(t) and v(t) cannot each be pure tones simultaneously. For the components to be pure tones, there must be three frequencies, w_{q}, wᵤ, and wᵥ, for which

q(t)=cos (w_{q}t)

u(t)=cos (wᵤt+Dᵤ)

v(t)=cos (wᵥt+Dᵥ)

q²(t)+u²(t)+v²(t)=1, (4)

where Dᵤ and Dᵥ are fixed phase shifts. It can be shown that this system of equations has no solutions with these constraints.

While a solution in which each of the components is a single tone cannot be found, a solution that only depends on three tones is possible. For example,

q(t)=cos (2ωt)

u(t)=(sin (ωt)+sin (3ωt))/2

v(t)=(−cos (ωt)+cos (3ωt)/2 (5)

The above equations satisfy the constraint q(t)²+u(t)²+v(t)=1 and describe a trajectory that produces only three tones in the signal from the power sensor.

A more detailed discussion of the considerations that go into choosing a trajectory on the Poincare sphere is provided below. For the purposes of the present discussion, it will be assumed that a trajectory for the Stokes vector on the Poincare sphere has been chosen.

Given a trajectory on the Poincare sphere, the potentials that must be applied to the electrodes on the polarization modulator must be determined. To provide these potentials for a known constant input polarization state, a calibration table that maps the voltages on the two electrodes onto polarizations on the Poincare sphere is constructed. For the purposes of this discussion, it will be assumed that the polarization modulator is a modulator such as that shown in FIGS. 3 and 4 and that electrode 53 is held at ground. The calibration table is constructed by applying a particular pair of voltages to electrodes 51 and 52 and then measuring the polarization of the light leaving port 44 using a conventional polarization analyzer that measures the three Stokes vector components.

This process can be more easily understood by referring to FIG. 5 and considering a specific example. When electrodes 51 and 52 are at ground, the polarization of the output light is at 61. When a set of two voltages is applied to electrodes 51 and 52, the Stokes vector moves to position 62. If a different set of two voltages is applied, the Stokes vector will move to some different point on the Poincare sphere. Hence, the polarization modulator can be calibrated by measuring the point on the sphere corresponding to each set of input voltages. In one embodiment, the voltage ranges are selected to cover the entire Poincare sphere. The calibration can be organized as a vector valued function of two variables, namely the two voltages on electrodes 51 and 52. Conversely, once a trajectory has been defined on the Poincare sphere, each point on the trajectory can be mapped to a pair of voltages to be applied to the electrodes. Once the sequence of voltages for each electrode is calculated, controller 24 shown in FIG. 1 can synthesize two waveforms, one for electrode 51, and one for electrode 52. Each waveform constitutes one period of a periodic modulation function that is applied to the corresponding electrode. The fundamental frequency for this periodic waveform is set to be consistent with the frequency limitations of the modulator and the power sensor.

Consider a normalized form of the Stokes vector (1, q(t), u(t), v(t)). Since the Stokes vector is modulated using a periodic modulation function, each of its components is also a periodic function. Hence, each component can be represented as a Fourier senes. The number of significant harmonics in the series depends on the details of the trajectory chosen on the Poincare sphere. For example, the trajectory described by Eq. (5) has only 3 significant harmonics. In the more general case, mathematically, the components of the polarization dependent components of the Stokes vector can be written in the following form

q(t)=C₁+A_{1,1} sin (wt+φ_{1,1})+A_{1,2} sin (2wt+φ_{1,2})+A_{1,3} sin (3wt+φ_{1,3})

u(t)=C₂+A_{2,1} sin (wt+φ_{2,1})+A_{2,2} sin (2wt+φ_{2,2})+A_{2,3} sin (3wt+φ_{2,3})

v(t)=C₃+A_{3,1} sin (wt+φ_{3,1})+A_{3,2} sin (2wt+φ_{3,2})+A_{3,3} sin (3wt+φ_{3,3}) (6)

The constants Cᵢ, φ_{i,j}, and A_{i,j}, where i=1 to 3 and j=1 to N, can be measured experimentally by measuring the output power from the polarization modulator for each Stokes' component using an appropriate polarization filter that removes two of the three components, i.e., by individually measuring q(t), u(t) and v(t). The constants A_{i,j} and φ_{i,j}, where i=1 to 3 and j=1 to N, represent amplitudes and phases of individual harmonics. The constants Cᵢ represent the unmodulated part of each Stokes component (0^{th} harmonic). The measurement of amplitude and phase of harmonics can be performed using a vector spectrum analyzer, a lock-in amplifier, or any other form of synchronous detection that allows simultaneous measurement of amplitude and phase. As will become clear from the following discussion, the number of harmonics that are significant, N, must be at least 3.

The above-described polarization modulation patterns all involve expanding the polarization dependent components of the Stokes vector in a harmonic series. That is, each component is expanded in terms of a number of component frequencies in which the component frequencies are integer multiples of some fundamental frequencies. However, as will be discussed in detail below, there are cases in which the polarization dependent components of the Stokes vector can be expanded in a series in which the frequencies are not integer multiples of a single fundamental frequency. The frequencies are predetermined by the polarization modulation. Hence, in the general case, it will be assumed that

q(t)=C₁+A_{1,1} sin (w₁t+φ_{1,1})+A_{1,2} sin (w₂t+φ_{1,2})+A_{1,3} sin (w₃t+φ_{1,3})

u(t)=C₂+A_{2,1} sin (w₁t+φ_{2,1})+A_{2,2} sin (w₂t+φ_{2,2})+A_{2,3} sin (w₃t+φ_{2,3})

v(t)−C₃+A_{3,1} sin (w₁t+φ_{3,1})+A_{3,2} sin (w₂t+φ_{3,2})+A_{3,3} sin (w₃t+φ_{3,3}) (6a)

As will become clear from the following discussion, there must be at least three frequencies wⱼ. In the case of a harmonic expansion, wⱼ=j*w, where w is the fundamental frequency.

The normalized power leaving the device under test is obtained by taking a dot product of the Stokes vector with the first row of the Mueller matrix, (m_{1,1}, m_{1,2}, m_{1,3}, m_{1,4}), as show in equation (3). Hence, the normalized power is expressed by the following equation:

p(t)=m_{1,1}+m_{1,2}q(t)+m_{1,3}u(t)+m_{1,4}v(t) (7)

where p(t) is the power measured by power sensor 23 shown in FIG. 1. Substituting the harmonic expansion discussed above for q(t), u(t), and v(t)

$$p ( t ) = {m}_{1 , 1} + {m}_{1 , 2} ( {C}_{1} + {A}_{1 , 1} sin ( {w}_{1} t + {ϕ}_{1 , 1} ) + {A}_{1 , 2} sin ( {w}_{2} t + {ϕ}_{1 , 2} ) + {A}_{1 , 3} sin ( {w}_{3} t + {ϕ}_{1 , 3} ) ) + {m}_{1 , 3} ( {C}_{2} + {A}_{2 , 1} sin ( {w}_{1} t + {ϕ}_{2 , 1} ) + {A}_{2 , 2} sin ( {w}_{2} t + {ϕ}_{2 , 2} ) + {A}_{2 , 3} sin ( {w}_{3} t + {ϕ}_{2 , 3} ) ) + {m}_{1 , 4} ( {C}_{3} + {A}_{3 , 1} sin ( {w}_{1} t + {ϕ}_{3 , 1} ) + {A}_{3 , 2} sin ( {w}_{2} t + {ϕ}_{3 , 2} ) + {A}_{3 , 3} sin ( {w}_{3} t + {ϕ}_{3 , 3} ) ) + higher order harmonics \qquad ( 8 a )$$

or, in a complex notation,

$$p ( t ) = {m}_{1 , 1} + {m}_{1 , 2} ( {C}_{1} + {z}_{1 , 1} exp ( j {w}_{1} t ) + {z}_{1 , 2} exp ( j {w}_{2} t ) + {z}_{1 , 3} exp ( j {w}_{3} , t ) ) + {m}_{1 , 3} ( {C}_{2} + {z}_{2 , 1} exp ( j {w}_{1} t ) + {z}_{2 , 2} exp ( j {w}_{2} t ) + {z}_{2 , 3} exp ( j {w}_{3} t ) ) + {m}_{1 , 4} ( {C}_{3} + {z}_{3 , 1} exp ( j {w}_{1} t ) + {z}_{3 , 2} exp ( j {w}_{2} t ) + {z}_{3 , 3} exp ( j {w}_{3} t ) ) + higher order harmonics \qquad ( 8 b )$$

Where j=\sqrt{−1} is an imaginary number. Assume that the power p(t) from power sensor 23 is analyzed in a vector spectrum analyzer that is part of controller 24 and that is capable of measuring amplitude and phase of individual frequency components. Denote the measured frequency components at angular frequencies w₁, w₂, and w₃ by p₁, p₂, and p₃, respectively. The quantities p₁, p₂, and p₃ are complex and contain the amplitude and phase. The detected DC term is represented by a real quantity p₀:

p₀=m_{1,1}+m_{1,2}C₁+m_{1,3}C₂+m_{1,4}C₃ (9a)

The quantities p₁, p₂, and p₃ are described by the equations:

p₁=m_{1,2}Z_{1,1}+m_{1,3}Z_{2,1}+m_{1,4}Z_{3,1}

p₂=m_{1,2}Z_{1,2}+m_{1,3}Z_{2,2}+m_{1,4}Z_{3,2}

p₃=m_{1,2}Z_{1,3}+m_{1,3}Z_{2,3}+m_{1,4}Z_{3,3} (9b)

If the light is on average depolarized, i.e., when the degree of polarization is 0, then C₁=C₂=C₃=0. In this case, equation (9a) takes the form:

p₀=m_{1,1} (9c)

This implies that the normalized power measurement at DC is a direct measure of the insertion loss of the device under test.
The equation (9b) can be rewritten in a matrix notation:

$$( \begin{matrix}{p}_{1} \\ {p}_{2} \\ {p}_{3}\end{matrix} ) = ( \begin{matrix}{z}_{1 , 1} & {z}_{1 , 2} & {z}_{1 , 3} \\ {z}_{2 , 1} & {z}_{2 , 2} & {z}_{2 , 3} \\ {z}_{3 , 1} & {z}_{3 , 2} & {z}_{3 , 3}\end{matrix} ) ( \begin{matrix}{m}_{1 , 1} \\ {m}_{1 , 2} \\ {m}_{1 , 3}\end{matrix} ) \qquad ( 9 d )$$

Here, the matrix Z is related to the A_{i,j} and φ_{i,j} discussed above. Hence, if the determinant of the matrix Z having the elements z_{i,j} is non-zero, this system of equations can be solved for the polarization-dependent Mueller matrix power coefficients m_{i,j}. It is important to note here that the reference phase of the phase sensitive detection process utilizing a vector spectrum analyzer or a lock-in amplifier implemented in software or hardware has to be properly chosen in order to provide a real solution for the Mueller elements. This can be accomplished by testing various reference phases and selecting the one that provides real valued Mueller elements.

After solving Eq. 9(d) for the Mueller matrix coefficients, the polarization dependent loss can be found from the following equation:

$$P D L = 10 log [ \frac{{m}_{11} + \sqrt{{m}_{1 , 2}^{2} + {m}_{1 , 3}^{2} + {m}_{1 , 4}^{2}}}{{m}_{11} - \sqrt{{m}_{1 , 2}^{2} + {m}_{1 , 3}^{2} + {m}_{1 , 4}^{2}}} ]$$

It should be noted that each of the Mueller matrix coefficients, m_{i,j} for j=2 to 4 can be viewed as representing a polarization dependent loss suffered by a light signal whose polarization was aligned with one of the Stokes vector space axes.

The above-described embodiments assume that the polarization modulator does not produce any intensity modulation. However, in practice, some intensity modulation is always present. In the previous embodiments the fluctuations of power were removed by a proper power normalization. Alternatively, the intensity modulation can be explicitly included in the equations. In this case, a non-normalized Stokes vector (i(t), q(t), u(t), v(t)) is considered. In this embodiment, it is assumed that the intensity fluctuation has the same period as other components of the Stokes vector. Then, just like other Stokes parameters, the intensity can be expressed by the following equation:

i(t)=C₀+A_{0,1} sin (w₁t+φ_{1,1})+A_{0,2} sin (w₂t+φ_{1,2})+A_{0,3} sin (w₃t+φ_{1,3})

This additional equation leads to the system of equations:

p₀=m_{1,1}C₀+m_{1,2}C₁+m_{1,3}C₂+m_{1,4}C₃

p₁=m_{1,1}Z_{0,1}+m_{1,2}Z_{1,1}+m_{1,3}Z_{2.1}+m_{1,4}Z_{3.1}

p₂=m_{1,1}Z_{0,1}+m_{1,2}Z_{1,2}+m_{1,3}Z_{2.2}+m_{1,4}Z_{3,2}

p₃=m_{1,1}Z_{0,1}+m_{1,2}Z_{1,3}+m_{1,3}Z_{2,3}+m_{1,4}Z_{3,3} (9e)

that can be solved by conventional methods. In this case, the trajectory no longer needs to provide a modulation pattern in which the degree of polarization of the modulated light is zero.

The above-described embodiments utilized only three of the harmonics in the Stokes vector components. However, embodiments in which more of the components are utilized to provide an over determined system in which noise is further reduced could be constructed. In addition, if the determinant of Z is 0 for some choice of the 3 harmonics, a matrix constructed from other harmonics may have a non-zero determinant.

In the above-described embodiments the designer determines the trajectory on the Poincare sphere and generates the modulation signals that are applied to the polarization modulator from a calibration model for that polarization modulator. The coefficients of the matrix Z are then measured experimentally. If the determinant of Z is zero, or too small to allow for an accurate solution of the system of equations, a new trajectory on the Poincare sphere is chosen and the process repeated.

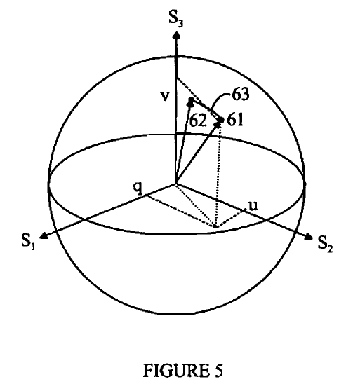

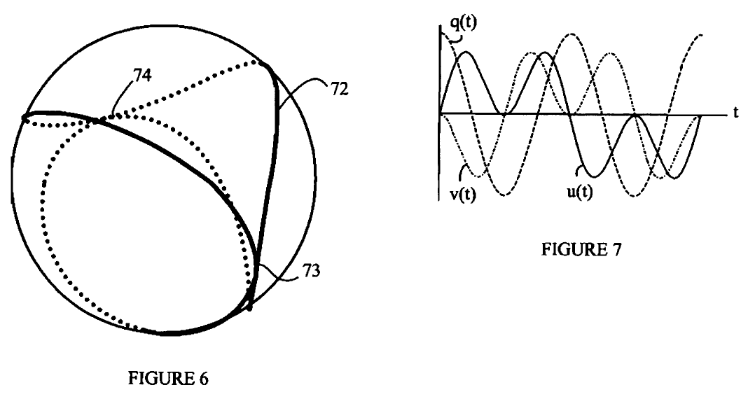

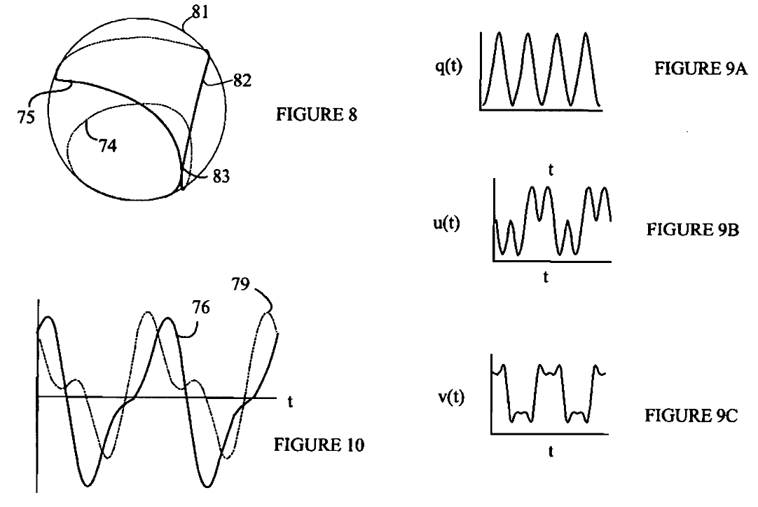

Alternatively a known trajectory as that described by the Eq. 5 discussed above can be used. The trajectory produces only three harmonics. The corresponding Z matrix is:

$$Z = ( \begin{matrix}0 & 1 & 0 \\ - j / 2 & 0 & - j / 2 \\ - 1 / 2 & 0 & 1 / 2\end{matrix} ) \qquad ( 10 )$$

where j=\sqrt{−1}. The determinant of the above matrix is equal to j/2. Refer now to FIGS. 6 and 7, which illustrate the trajectory described by Eq. (5). FIG. 6 shows the trajectory on the Poincare sphere, and FIG. 7 is a graph of the individual Stokes vector components. Referring to FIG. 6, trajectory 72 is topologically a FIG. 8 having two loops that are joined at the two points shown at 73 and 74.

The choice of trajectory from among those that generate matrices that have non-zero determinants can be guided by some general principles that are listed below. Trajectories that generate fewer harmonics for all Stokes vector components are preferred. Only three harmonics are needed to solve for the corresponding coefficients of the Mueller matrix. The additional harmonics divert energy that would have gone into the harmonics that are being used; hence, trajectories that generate a significant number of additional harmonics are likely to lead to lower signal-to-noise ratios.

The number of harmonics that are generated by any given trajectory may depend on the number of harmonics in the corresponding drive signals that are applied to the electrodes in the polarization modulator. Also, complicated voltage waveforms are more difficult to synthesize, and hence, can lead to more complex driving circuitry for the modulator.

There is also a limit on the voltages that can be generated by the controller and applied to the polarization modulator. Hence, a trajectory on the Poincare sphere must be traversable using voltages that are within some predetermined range of voltages that are determined by the polarization modulator and the controller.

Refer now to FIGS. 8-9, which illustrate an exemplary trajectory that is utilized in one embodiment of the present invention. FIG. 8 is a prospective view of Poincare sphere 81. FIGS. 9A-9C illustrate the Stokes vector components generated by the polarization modulator traversing trajectory 82. Trajectory 82 is topologically a FIG. 8 path having a first loop 75 in the northern hemisphere of Poincare sphere 81 and a second loop 74 in the southern hemisphere of Poincare sphere 81. The loops meet at point 83 on the equator. Both loops are traversed clockwise as viewed by an observer located on the outside of the sphere.

The modulation of the various Stokes vector components are shown in FIGS. 9A-9C. As noted above, at least some of the Stokes vector components have modulation functions that include a number of harmonics that can be used to solve for the Mueller matrix components as discussed above. Refer now to FIG. 10, which illustrates the voltage waveforms 76 and 79 that are applied to electrodes 51 and 52 shown in FIGS. 3 and 4 that cause the Stokes vector to move about trajectory 82. Voltage waveforms 76 and 79 contain two cycles and correspond to two evolutions along the trajectory. The reference electrode 53 is held at ground in this embodiment.

The above-described trajectories on the Poincare sphere are closed loops, and hence, the modulation frequencies are harmonics of the frequency with which the closed loop is traversed. For the purposes of the present discussion, a path will be defined as being closed if it begins and ends at the same point on the Poincare sphere. This will always be the case when the Stokes vector is a periodic function. In some cases, it may be advantageous to use modulation frequencies that are unrelated frequencies instead of harmonics. For example, such unrelated frequencies could reduce some errors caused by harmonics produced by non-linearities of the power sensor. Trajectories in which the Stokes vector components are modulated in a periodic manner without requiring the trajectory to be closed are possible. An example of such a trajectory is given by

q(t)=cos (2ω₁t)

u(t)=(sin (2ω₁t−ω₂t)+sin (2ω₁t+ω₂t))/2

v(t)=(cos (2ω₁t−ω₂t)+cos (2ω₁t+ω₂t))/2 (11)

with ω₁=eω/2 and ω₂=ω. Here e is the irrational number, 2.71828. . . . The controller detects modulation at (e−1) ω, eω, and (e+1) ω, where ω is chosen to provide detection at frequencies that are within the range of the analyzer contained within the controller. It should be noted that while the Stokes vector components are described by periodic functions, the trajectory defined by Eq. (11) is not periodic. The path define by Eq. (11) eventually samples the entire Poincare sphere surface without repeating itself.

The above-described embodiments of the present invention utilize a light source that has a fixed polarization state. The light source can be a tunable laser light source that allows characterization of components over wavelength. The fixed polarization state of the laser source is modulated by the polarization modulator. Highly monochromatic tunable laser sources are very attractive in embodiments in which the device under test includes an optical fiber, optical fiber components, or other devices having fiber interfaces or small dimensions. However, embodiments based on other light sources such as LEDs can also be constructed. If the light source does not provide light with a constant fixed polarization, a polarization filter can be introduced between the light source and the polarization modulator or as part of the input port of the polarization modulator.

The controller 24 from FIG. 1, utilized in the above-described embodiments, can be any data processing system that is capable of: generating the required potentials for the polarization modulator, reading the power information from the power sensor, synchronously detecting arbitrary complex harmonics, and solving the system of equations that provide the first raw Mueller matrix elements and, consequently, insertion loss and polarization dependent loss. General-purpose signal generation and data processing systems or special purpose hardware can be utilized to construct such a controller. The controller can include specialized hardware for performing the synchronous detection functions discussed above or these functions could be implemented in software running on controller 24. In addition, these functions could be implemented in a combination of special purpose hardware and software.

Various modifications to the present invention will become apparent to those skilled in the art from the foregoing description and accompanying drawings. Accordingly, the present invention is to be limited solely by the scope of the following claims.

What is claimed is:

1. An apparatus comprising:
a light source that generates a polarization modulated light signal, said light source being adapted to apply said polarization modulated light signal to a device under test;
a sensor that generates an electrical output signal representing an intensity of an output light signal leaving said device under test as a function of time; and
a controller that measures said electrical output signal at a first frequency and generates an output indicative of a polarization dependent loss in said device under test.

2. The apparatus of claim 1 wherein said controller measures amplitude and phase of said electrical output signal.

3. The apparatus of claim 1 wherein said controller also measures an insertion loss associated with said device under test.

4. The apparatus of claim 1 wherein said polarization modulated light signal comprises a light signal in which all three Stokes vector polarization components comprise periodic functions of time.

5. The apparatus of claim 4 wherein said modulation frequencies comprise first, second, and third modulation frequencies, wherein said controller measures an amplitude and phase of said electrical output signal at each of said first, second, and third modulation frequencies, and wherein said first frequency is one of said modulation frequencies.

6. The apparatus of claim 5 wherein said first, second, and third modulation frequencies are integer multiples of a common frequency.

7. The apparatus of claim 5 wherein said first, second, and third modulation frequencies are not integer multiples of a common frequency.

8. The apparatus of claim 1 wherein said polarization modulated light signal is characterized by a path on a Poincare sphere and wherein said path is closed.

9. The apparatus of claim 8 wherein-said path is topologically a FIG. 8.

10. The apparatus of claim 1 wherein said polarization modulated light signal is characterized by a path on a Poincare sphere and wherein said path is not closed.

11. The apparatus of claim 1 wherein said polarization modulated light source comprises light having a constant polarization component and a time varying polarization component.

12. The apparatus of claim 1 wherein said light source comprises a polarized light source and a polarization modulator and wherein said controller determines alterations in a polarization component of light from said polarized light signal.

13. The apparatus of claim 1 wherein said controller comprises an electrical vector spectrum analyzer or a lock-in amplifier.

14. The apparatus of claim 1 wherein said controller determines an element in the first row of the Mueller matrix that characterizes said device under test.

15. The apparatus of claim 12 wherein said polarization modulator comprises a LiNbO₃ crystal having a plurality of electrodes on a surface thereof and wherein said controller further comprises a signal generator for applying periodic potentials to said electrodes.

16. A method for measuring a polarization dependent loss characterizing a device under test, said method comprising:
applying a polarization modulated light signal to said device under test;
generating an electrical output signal representing an intensity of a light signal leaving said device under test;
measuring said electrical output signal at a first frequency and generating an output indicative of a polarization dependent loss in said device under test.

17. The method of claim 16 wherein an amplitude and a phase of said electrical output signal is measured.

18. The method of claim 16 wherein said polarization modulated light signal comprises a light signal in which all three Stokes vector polarization components are periodic functions of time and wherein an amplitude and phase of said electrical output signal at each of a plurality of frequencies characterizing said periodic functions of time is measured in determining said polarization dependent loss.

19. The method of claim 16 wherein said polarization modulated light signal is generated by passing a light signal having a fixed polarization through a polarization modulator that alters said fixed polarization in a manner determined by signals applied to said light modulator and wherein said method further comprises determining a calibration mapping that provides a relationship between said signals and said alterations in said fixed polarization.

20. The method of claim 16 wherein an amplitude and a phase of said electrical output signal are measured with a device having a reference phase and wherein said reference phase is set such that coefficients of a Mueller matrix characterizing said device under test that are determined from said intensities and phases are real numbers.
